(19) United States
(12) Patent Application Publication
(10) Pub. No.: US 2021/0384506 A1
(43) Pub. Date: Dec. 9, 2021

(54) ELECTRODE INCLUDING A LAYERED/ROCKSALT INTERGROWN STRUCTURE

(71) Applicant: The Regents of the University of California, Oakland, CA (US)

(72) Inventors: Wei Tong, Albany, CA (US); Ning Li, El Cerrito, CA (US); Meiling Sun, Oakland, CA (US); Jing Xu, Mountain View, CA (US)

(21) Appl. No.: 17/339,651

(22) Filed: Jun. 4, 2021

Related U.S. Application Data
(60) Provisional application No. 63/035,072, filed on Jun. 5, 2020.

(51) Int. Cl. H01M 4/525; H01M 10/0525; H01M 4/505; H01M 4/1391

(52) U.S. Cl. CPC H01M 4/525; H01M 10/0525; H01M 2004/028; H01M 4/1391; H01M 4/505

(57) ABSTRACT

This disclosure provides systems, methods, and apparatus related to cathode materials for lithium ion batteries. In one aspect, a structure comprises an oxide including lithium and two or more transition metals. A first portion of the oxide is in a layered phase and a second portion of the oxide is in a rocksalt phase. The first potion of the oxide and the second portion of the oxide form a layered-rocksalt intergrown structure.

### RELATED APPLICATIONS

This application claims priority to U.S. Provisional Patent Application No. 63/035,072, filed Jun. 5, 2020, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### TECHNICAL FIELD

This disclosure relates generally to lithium-ion batteries and more particularly to cathodes for lithium-ion batteries.

### BACKGROUND

The increasing demand for rechargeable lithium-ion batteries of high energy and power density facilitates the continuous search for even better battery electrodes, of which the cathode appears to be a limiting factor. Commercially viable layered oxide cathodes (e.g., LiCoO₂ and its variants (LiNi_{1-x-y}MnₓCo_{y}O₂, LiNi_{1-x-y}CoₓAl_{y}O₂, 0<x, y<0)) operate predominantly based on the oxidizable transition metal (TM) and extractable Li⁺ hosted in the close-packed oxygen sublattice. These layered compounds typically exhibit high rate capability. However, they are still incapable of delivering their theoretical capacity because of the irreversible structural change at highly delithiated states.

In contrast, Li-rich metal oxides of cation-ordered (layered) and disordered rocksalt can consistently deliver a high reversible capacity of 250-300 mAh g⁻¹, based on combined cationic TM and anionic oxygen redox. However, a Li-rich layered oxide cathode suffers from an irreversible layered-to-spinel/rocksalt phase transformation, accompanied by lattice oxygen loss, leading to severe capacity and voltage decay upon electrochemical cycling. Mitigating these effects for practical application remains a challenge. Li-excess disordered rocksalt, although with a minimal isotropic structural change upon (de)lithiation, needs to be pulverized to nanoscale and cycled at low currents.

### BRIEF DESCRIPTION OF THE DRAWINGS

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

FIGS. 1A-1F show the characterization of the Li_{1.2}Ni_{0.4}Ru_{0.4}O₂ of layered-rocksalt intergrown structure. sXRD (FIG. 1A) and ND (FIG. 1B) patterns with Rietveld fits for Li_{1.2}Ni_{0.4}Ru_{0.4}O₂ are shown. Refinement was performed based on R3̅m and Fm3̅m biphasic model, indicating 70 mol % R3̅m (a=2.94194(7) Å, c=14.40729(2) Å and V=107.990(1) Å³) and 30 mol % Fm3̅m (a=4.15874(6) Å and V=71.926(1) Å³). Critical reflections are indexed as (hkl)_{L} and (hkl)_{R} for R3̅m and Fm3̅m, respectively. FIG. 1C shows a representative HAADF-STEM image and FFT (FIGS. 1D and 1E) of the selected areas highlighted boxes, showing the layered-rocksalt intergrown structure along the [110] zone axis. Scale bar is 2 nm. FIG. 1F shows a schematic of layered-rocksalt intergrown structure along the [110] zone axis, the center portion showing the structurally compatible region with different TM arrangements in the Li slabs.

FIGS. 2A-2E show the electrochemical characterization of Li_{1.2}Ni_{0.4}Ru_{0.4}O₂. FIG. 2A shows the first cycle voltage profiles, FIG. 2B shows dx/dV plots, and FIG. 2C shows voltage profiles during the first five cycles at different charge cutoff voltages. FIG. 2D shows voltage profiles and FIG. 2E shows dQ/dV plots at different rates. Cells are cycled at 5 mA g⁻¹ in FIGS. 2A-2C and between 4.6 and 2.5 V in FIGS. 2D and 2E.

FIGS. 3A-3D show the nearly zero-strain isotropic structural evolution of Li_{1.2}Ni_{0.4}Ru_{0.4}O₂ upon delithiation/lithiation. FIG. 3A shows in situ sXRD of Li_{1.2}Ni_{0.4}Ru_{0.4}O₂, the pattern at the bottom is the background from the in situ cell; cell was cycled between 4.8 and 2.5 V at C/10. FIG. 3B shows sXRD of Li_{1.2}Ni_{0.4}Ru_{0.4}O₂ (x=1.2, 0.5, 0.2, 0) prepared by chemical delithiation method. FIGS. 3C and 3D show joint refinement of sXRD (FIG. 3C) and ND (FIG. 3D) patterns of Li_{1.2}Ni_{0.4}Ru_{0.4}O₂. Critical reflections are indexed as (hkl)_{L} and (hkl)_{R} for R3̅m and Fm3̅m, respectively.

FIGS. 4A-4E shown the cationic redox mechanism of Li_{1.2}Ni_{0.4}Ru_{0.4}O₂. FIG. 4A shows voltage profiles and dQ/dV plot of Li_{1.2}Ni_{0.4}Ru_{0.4}O₂, showing samples (open circles) for ex situ XAS analysis. FIGS. 4B and 4C show XANES of Ru K-edge. FIG. 4D and 4E show XANES of Ni K-edge. FIG. 4F shows Ni and Ru K-edge energy measured at half maxima at different states of charge.

FIGS. 5A-5F show the anionic redox mechanism of Li_{1.2}Ni_{0.4}Ru_{0.4}O₂. O K-edge mRIXS results at different electrochemical states. Arrows indicate the fingerprinting feature of oxidized oxygen at the excitation and emission energy of 531 and 523.7 eV, respectively. The feature emerges at 4.1 V during charge, and disappears in the following discharge, clearly revealing a reversible lattice oxygen redox reaction.

FIGS. 6A and 6B show the new Li-rich metal oxides of different Ni/Ru combination. FIG. 6A shows XRD patterns based on Ni²⁺/Ru⁵⁺ combination, showing the layered-rocksalt intergrown structure. The designed layered-rocksalt samples Li_{7/6}Ni_{4/9}Ru_{7/18}O₂, Li_{5/4}Ni_{1/3}Ru_{5/12}O₂, and Li_{4/3}Ni_{2/9}Ru_{4/9}O₂ are labeled as LR1, LR2 and LR3, respectively. FIG. 6B shows XRD patterns based on varied oxidation states of Ni/Ru, where Ni²⁺/Ru⁴⁺ in Li_{1.2}Ni_{0.2}Ru_{0.6}O₂ and Ni³⁺/Ru⁵⁺ in Li_{1.2}Ni_{0.6}Ru_{0.2}O₂ lead to layered structure vs. layered-rocksalt intergrown structure for Ni²⁺/Ru⁵⁺ in Li_{1.2}Ni_{0.4}Ru_{0.4}O₂. Critical reflections are indexed as (hkl)_{L} and (hkl)_{R} for R3̅m and Fm3̅m, respectively.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

Layered and rocksalt structure share a similar close-packed oxygen framework, but with different arrangements in Li and TM: layered structure exhibits cation ordering between alternating Li and TM slabs, while Li and TM are mostly randomly distributed in the disordered rocksalt. Therefore, it is possible in principle to develop a material that integrates the favored structural and electrochemical attributes of both layered and rocksalt structure. So far, very limited success has been achieved to utilize the structural compatibility of layered and rocksalt phases for the development of high-performance Li-ion cathodes.

We propose and demonstrate a concept of layered-rocksalt intergrown structure for the development of advanced Li-ion cathode, which is intrinsically different from the well-known Li/TM intermixing or the formation of densified surface phase in layered cathode during synthesis or upon electrochemical cycling. Such a layered-rocksalt intergrown structure harnesses the favored figures of merit from each individual component: (1) the inherently high capacity of layered and rocksalt phases; (2) good kinetics (rate capability) from the facile Li⁺ diffusion in the layered oxide; and (3) isotropic structural change with largely reduced mechanical stress benefiting from the interwoven rocksalt phase.

In some embodiments, a structure comprises an oxide including lithium and two or more transition metals. A first portion of the oxide is in a layered phase and a second portion of the oxide is in a rocksalt phase. The first potion of the oxide and the second portion of the oxide form a layered-rocksalt intergrown structure.

In some embodiments, the layered-rocksalt structure comprises nanodomains of the rocksalt phase dispersed in the layered phase. In some embodiments, the layered-rocksalt structure is intergrown into the layered phase. In some embodiments, the nanodomains are about 3 nanometers to 100 nanometers in size. In some embodiments, the structure comprises about 20 mol percent to 33 mol percent of the rocksalt phase and about 67 mol percent to 80 mol percent of the layered phase. In some embodiments, the structure comprises about 30 mol percent of the rocksalt phase and about 70 mol percent of the layered phase.

In some embodiments, the transition metals comprise nickel and ruthenium. In some embodiments, the transition metals consist of nickel and ruthenium. In some embodiments, the oxide comprises a lithium nickel ruthenium oxide. In some embodiments, the oxide comprises Li[Li_{1-x-y}(Ni²⁺)ₓ(RU⁵⁺)_{y}]O₂, with 0.03<1-x-y<0.47. In some embodiments, the oxide is selected from a group consisting of Li_{1.2}Ni_{0.4}Ru_{0.4}O₂, Li_{7/6}Ni_{4/9}Ru_{7/18}O₂, Li_{5/4}Ni_{1/3}Ru_{5/12}O₂, and Li_{4/3}Ni_{2/9}Ru_{4/9}O₂. In some embodiments, the oxide is Li_{1.2}Ni_{0.4}Ru_{0.4}O₂. In some embodiments, the oxide includes a dopant selected from a group consisting of Sc, Ti, V, Cr, Co, Cu, Zn, Y, Zr, Nb, Mo, Ta, and W, with 0<(dopant atomic percentage)≤0.1.

In some embodiments, the transition metals comprise nickel, iron, and manganese. In some embodiments, the transition metals consist of nickel, iron, and manganese. In some embodiments, the oxide comprises a lithium nickel iron manganese oxide. In some embodiments, the oxide comprises Li[Li_{1-x-y-z}NiₓFe_{y}Mn_{z}]O₂, with 0.03<1-x-y-z<0.47. In some embodiments, the oxide is selected from a group consisting of Li_{1.15}Ni_{0.20}Fe_{0.15}Mn_{0.50}O₂, Li_{1.15}Ni_{0.15}Fe_{0.25}Mn_{0.45}O₂, Li_{1.10}Ni_{0.20}Fe_{0.30}Mn_{0.40}O₂, and Li_{1.10}Ni_{0.30}Fe_{0.10}Mn_{0.50}O₂. In some embodiments, the oxide includes a dopant selected from a group consisting of Sc, Ti, V, Cr, Co, Cu, Zn, Y, Zr, Nb, Mo, Ta, and W, with 0<(dopant atomic percentage)≤0.1.

In some embodiments, the structure is incorporated in a cathode of a lithium-ion battery.

In some embodiments, a method for manufacturing a lithium metal oxide having a general formula Li[Li_{1-x-y}(Ni²⁺)ₓ(Ru⁵⁺)_{y}]O₂, with 0.03<1-x-y<0.47, comprises providing a lithium-based precursor, providing a nickel-based precursor, and providing a ruthenium-based precursor. The lithium-based precursor, the nickel-based precursor, and the ruthenium-based precursor are mixed to form a mixture. A first portion of the lithium metal oxide is in a layered phase and a second portion of the lithium metal oxide is in a rocksalt phase. The first potion of the lithium metal oxide and the second portion of the lithium metal oxide form a layered-rocksalt intergrown structure.

In some embodiments, the method further comprises after the mixing, annealing the mixture at about 700° C. to 1200° C. for about 5 hours to 18 hours under an oxygen atmosphere or in air. In some embodiments, the mixture is annealed at about 950° C. for about 15 hours in air. In some embodiments, the mixing comprises ball milling.

In some embodiments, the lithium-based precursor is selected from a group consisting of Li₂CO₃, LiOH, Li₂O, Li₂SO₄, LiCl, LiNO₃, and combinations thereof. In some embodiments, the lithium-based precursor is lithium carbonate. In some embodiments, the nickel-based precursor is selected from a group consisting of NiO, Ni₂O₃, Ni(OH)₂, and NiCO₃. In some embodiments, the nickel-based precursor is nickel hydroxide. In some embodiments, the ruthenium-based precursor is RuO₂.

In some embodiments, stoichiometric amounts of the lithium-based precursor, the nickel-based precursor, and the ruthenium-based precursor are mixed, with the lithium-based precursor is added in up to 15% excess of a specified lithium composition.

In some embodiments, a method for manufacturing a lithium metal oxide having a general formula Li[Li_{1-x-y-z}NiₓFe_{y}Mn_{z}]O₂, with 0.03<1-x-y-z<0.47, comprises providing a lithium-based precursor, providing a nickel-based precursor, providing an iron-based precursor, and providing a manganese-based precursor. The lithium-based precursor, the nickel-based precursor, the iron-based precursor, and the manganese-based precursor are mixed to form a mixture. A first portion of the lithium metal oxide is in a layered phase and a second portion of the lithium metal oxide is in a rocksalt phase. The first potion of the lithium metal oxide and the second portion of the lithium metal oxide form a layered-rocksalt intergrown structure.

In some embodiments, the method further comprises after the mixing, annealing the mixture at about 700° C. to 1200° C. for about 5 hours to 18 hours under an oxygen atmosphere or in air. In some embodiments, the mixture is annealed at about 900° C. for about 16 h in air. In some embodiments, the mixing comprises ball milling.

In some embodiments, the lithium-based precursor is selected from a group consisting of Li₂CO₃, LiOH, Li₂O, Li₂SO₄, LiCl, LiNO₃, and combinations thereof. In some embodiments, the lithium-based precursor is lithium carbonate. In some embodiments, the nickel-based precursor is selected from a group consisting of NiO, Ni₂O₃, Ni(OH)₂, and NiCO₃. In some embodiments, the nickel-based precursor is nickel hydroxide. In some embodiments, the iron-based precursor is selected from a group consisting of FeC₂O₄, FeO, and Fe₂O₃. In some embodiments, the iron-based precursor is iron oxalate. In some embodiments, the manganese-based precursor is selected from a group consisting of MnCO₃, MnO₂, MnO, and Mn₂O₃. In some embodiments, the manganese-based precursor is manganese carbonate.

In some embodiments, stoichiometric amounts of the lithium-based precursor, the nickel-based precursor, and the iron-based precursor, and the manganese-based precursor are mixed, with the lithium-based precursor being added in up to 15% excess of a specified lithium composition.

In some embodiments, a battery comprises an anode, a cathode, and an electrolyte. The cathode comprises an oxide including lithium and two or more transition metals. A first portion of the oxide is in a layered phase and a second portion of the oxide is in a rocksalt phase. The first potion of the oxide and the second portion of the oxide form a layered-rocksalt intergrown structure.

The following examples are intended to be examples of the embodiments disclosed herein, and are not intended to be limiting.

### EXAMPLES

As described below, we designed and synthesized lithium nickel ruthenium oxides based on a Ni²⁺/Ru⁵⁺ combination, Li_{1.2}Ni_{0.4}Ru_{0.4}O₂, which exhibits a main layered structure (R3̅m) with well-grown rocksalt (Fm3̅m) nanodomains. Li_{1.2}Ni_{0.4}Ru_{0.4}O₂ delivers a high reversible capacity of 240-330 mAh g⁻¹ with good rate capability. We unraveled an intriguing isotropic structural evolution with a negligible change in crystal lattice upon Li⁺ (de)insertion, resembling that of the disordered rocksalt. We also verified that the design of such intergrown structure requires TM with appropriately selected ionic radius and/or valence state, as well as electronic configuration. Because both phases accommodate a vast composition space, given the excellent tolerance for stoichiometry and TM combination in layered and disordered rocksalts, our demonstration opens up opportunities in developing high-performance intergrown electrode materials.

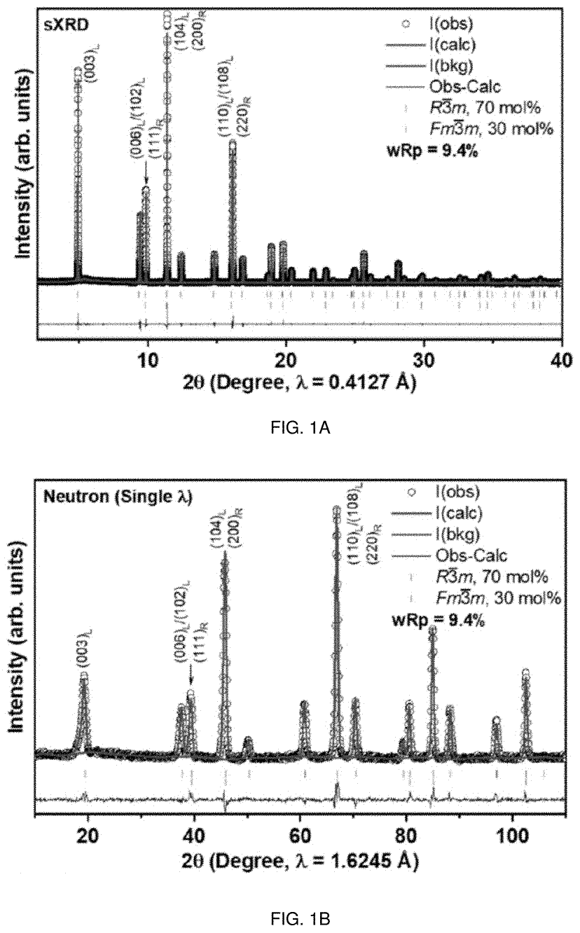

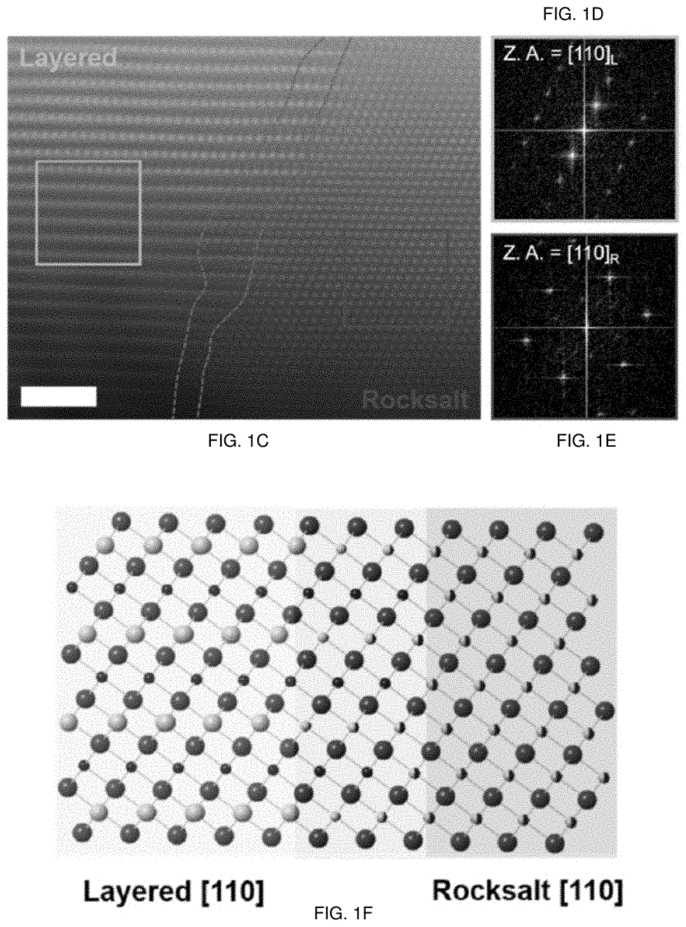

Results Layered-Rocksalt Intergrown Structure. Li_{1.2}Ni_{0.4}Ru_{0.4}O₂ was prepared by a solid state reaction and the crystal structure at pristine state was carefully examined by a joint synchrotron X-ray diffraction (sXRD) and neutron diffraction (ND). All the reflections in FIGS. 1A and 1B can be well indexed based on layered R3̅m structure. Particularly, no super-lattice peaks in the 2θ region of 5-9° (λ=0.4127 Å), originating from the Li/TM ordering in the TM slabs, were noticed in sXRD of Li_{1.2}Ni_{0.4}Ru_{0.4}O₂. Rietveld refinement of sXRD for pristine Li_{1.2}Ni_{0.4}Ru_{0.4}O₂ based on R3̅m space group led to a good fit in the peak position. But a discrepancy in the peak intensity was revealed, especially for the intensity ratio of reflection (003)/(104), which is an important indicator of the degree of cation ordering in layered R3̅m phase. Low intensity ratio of reflection (003)/(104) in layered R3̅m could be due to Li/Ni intermixing because of the similar ionic radius of Li⁺ (0.76 Å) and Ni²⁺ (0.69 Å). Simulation of XRD patterns based on R3̅m clearly showed the decreased intensity of (003) reflection with respect to (104) reflection when the level of Li/Ni mixing increased. Additional simulated XRD and ND patterns for R3̅m and Fm3̅m were calculated. Therefore, further joint refinement of sXRD and ND was performed based on single R3̅m phase model with Li/Ni intermixing. A single R3̅m phase model that allows Li/Ni intermixing resulted in a better fit in peak intensity with a final R-factor of 13.8%, revealing ˜8.0% Li/Ni intermixing. Meanwhile, close comparison of the calculated and observed XRD patterns revealed the deviation of the reflections around 9.9, 11.4, and 16.1° (λ=0.4127 Å), which is in accordance with the characteristic reflections of rocksalt phase. Furthermore, a joint refinement based on layered-rocksalt biphasic model led to an even lower R-factor of 9.4%, and the optimal refinement indicates the final product was composed of 70 mol % layered and 30 mole % rocksalt phase (FIGS. 1A and 1B).

To further verify the structure of Li_{1.2}Ni_{0.4}Ru_{0.4}O₂, high-angle annular dark field-scanning transmission electron microscopy (HAADF-STEM) was employed to directly visualize the atomic distribution of TMs. A number of particles were examined and a representative HAADF-STEM image is shown in FIGS. 1C-1E. HAADF-STEM clearly revealed the typical layered arrangement of TMs in one domain (left) and rocksalt pattern in the other domain (right), also confirmed by fast Fourier transformation (FFT) (FIG. 1C). More importantly, the layered-rocksalt components were not randomly separated in crystal grains, instead, they exhibited an intergrown structure that firmly anchors the rocksalt domain in the main layered phase. Careful examination of the boundary between layered and rocksalt domain revealed a structurally compatible region, where a gradual transition is clearly distinguished by different TM distribution in the Li slabs, as opposed to a grain boundary. Electron energy loss spectroscopy (EELS) mapping of the pristine Li_{1.2}Ni_{0.4}Ru_{0.4}O₂ revealed uniform elemental distribution in both rocksalt and layered regions. Therefore, our combined sXRD, ND and STEM analysis consistently and unambiguously revealed the new layered-rocksalt intergrown structure for pristine Li_{1.2}Ni_{0.4}Ru_{0.4}O₂ (FIG. 1F).

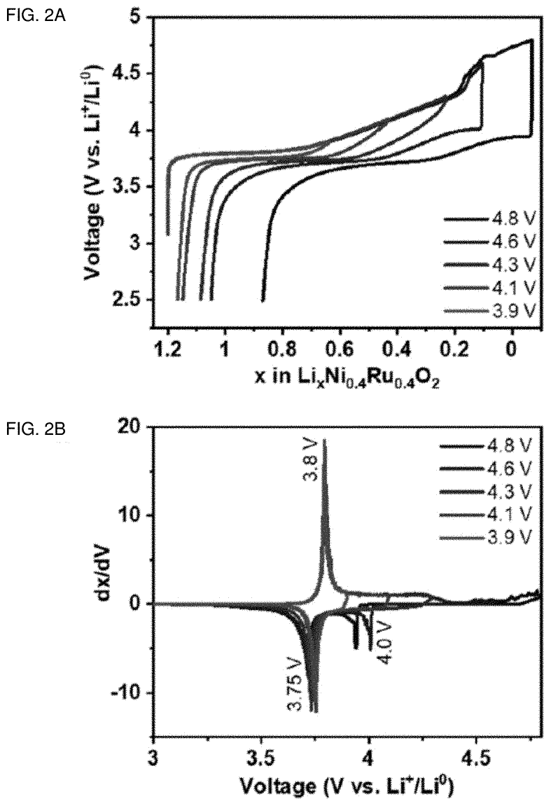

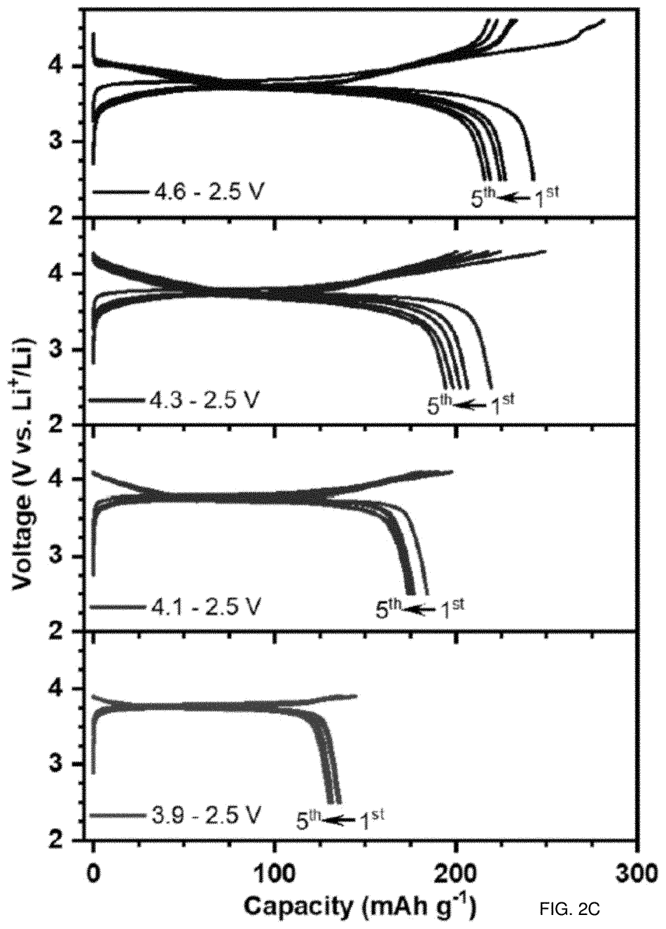

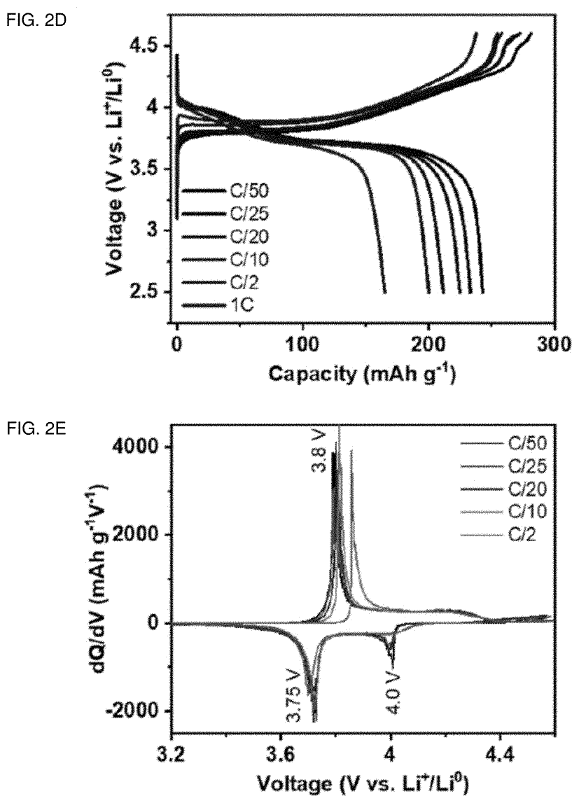

Results Electrochemical Characterization. Electrochemical activity of Li_{1.2}Ni_{0.4}Ru_{0.4}O₂ with a layered-rocksalt intergrown structure (FIGS. 2A-2E) was investigated directly on the as-produced material with a particle size of ˜500 nm without further modification. It was initially subjected to galvanostatic charge and discharge testing at various charge cutoff voltages, ranging from 3.9 to 4.8 V. We revealed continuous Li⁺ extraction and increased Li⁺ uptake upon increasing charge cutoff voltage (FIG. 2A). Li_{1.2}Ni_{0.4}Ru_{0.4}O₂ displayed the best electrochemical reversibility between 4.6 and 2.5 V, featured by ˜1.1 Li⁺ extraction and 0.95 Li⁺ re-insertion (244 mAh g⁻¹ and 904 Wh Kg⁻¹) during charge and discharge, respectively. Given the total of 1.2 Li⁺ inventory in the material, such a layered-rocksalt intergrown oxide enables high % of Li⁺ extraction/insertion, which is comparable to that in Li-rich layered oxide and disordered rocksalt. No additional reversible capacity was gained beyond 4.6 V charge cutoff. Further expanding the voltage window to 4.8-1.5 V led to a discharge capacity of 333 mAh g⁻¹. The differential capacity curves (FIG. 2B) were characterized by a sharp anodic peak around 3.8 V upon charge with a common cathodic peak around 3.75 V upon discharge, perhaps relating to Ni redox. Ni²⁺/Ru⁵⁺ or Ni³⁺/Ru⁴⁺ combination is possible in Li_{1.2}Ni_{0.4}Ru_{0.4}O₂. Nickel can be electrochemical active through Ni²⁺/Ni⁴⁺ (2 e⁻) or Ni³±/Ni⁴⁺ (1 e⁻), but only Ru⁴⁺/Ru⁵⁺ redox is possible for Ruthenium. In either case, TM redox can only account for 0.8 Li⁺ (206 mAh g⁻¹). Interestingly, an additional cathodic peak around 4 V started to evolve when the charge cutoff voltage reached 4.6 V, indicating the possible contribution of oxygen redox in the high voltage region. Meanwhile, Li_{1.2}Ni_{0.4}Ru_{0.4}O₂ demonstrated better capacity retention at cutoff voltages <4.3 V (FIG. 2C). The rate capability was also evaluated directly on Li_{1.2}Ni_{0.4}Ru_{0.4}O₂ at the rates ranging from C/50 to 1 C between 4.6 and 2.5 V. The material delivered a discharge capacity of 200 and 165 mAh g⁻¹ at C/2 and 1 C, respectively (FIG. 2D). With increasing current density, the charge and discharge profiles mostly retain, characterized by a pair of anodic/cathodic peaks around 3.75 V (FIG. 2E), while the cathodic peak around 4 V remains at low rates and becomes less pronounced at ≥C/10, in accordance with slightly high polarization at >4 V discharge observed by Galvanostatic intermittent titration technique (GITT). In general, the layered-rocksalt intergrown Li_{1.2}Ni_{0.4}Ru_{0.4}O₂ displayed a high capacity and good rate capability, more importantly, it largely mitigated the notorious hysteresis of typical Li-rich layered oxides during initial cycles.

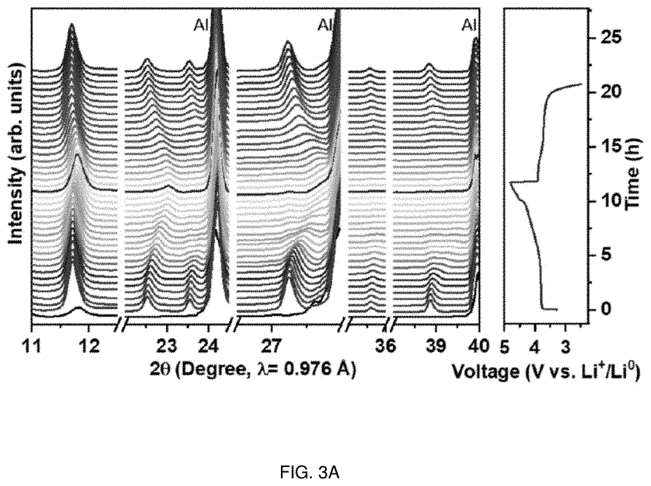

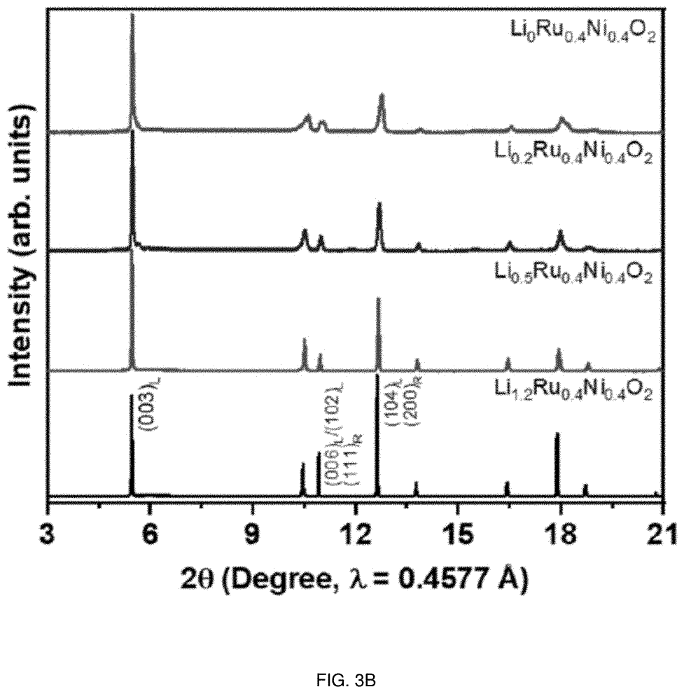

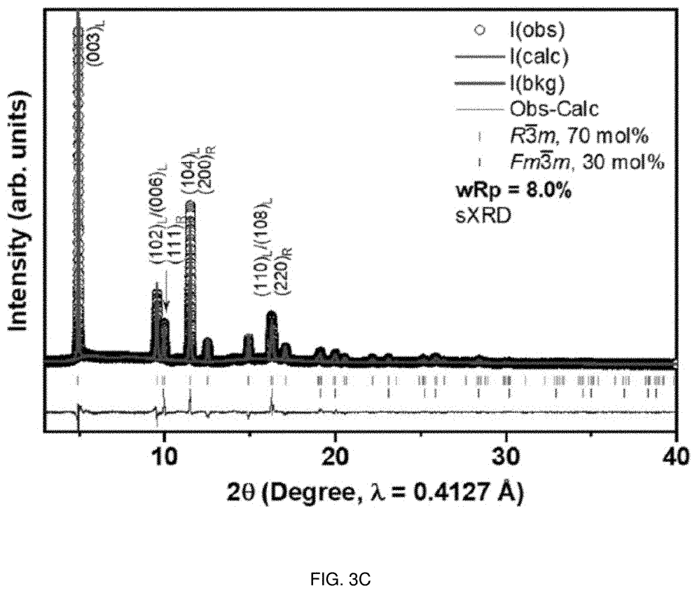

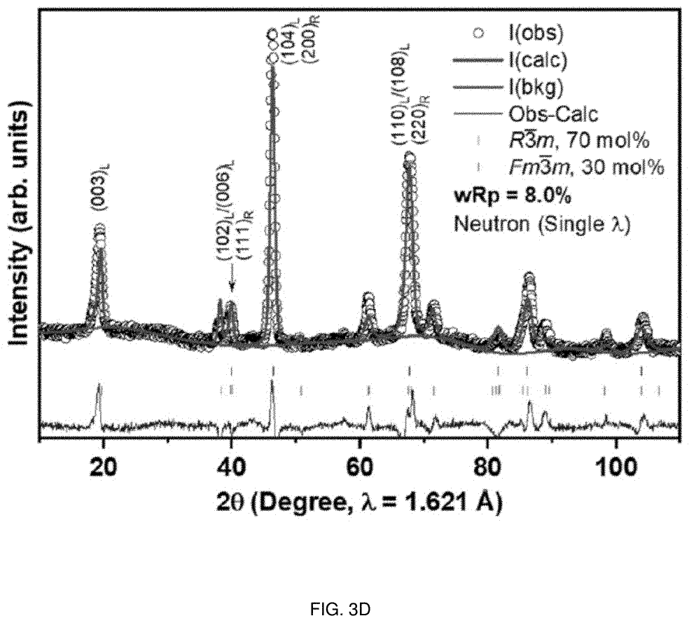

Results Isotropic and Nearly Zero-Strain Structural Evolution. To investigate the evolution of layered-rocksalt intergrown structure upon electrochemical cycling, in situ sXRD patterns were collected on a pouch cell composed of Li_{1.2}Ni_{0.4}Ru_{0.4}O₂//Li between 4.8 and 2.5 V at C/10 (FIG. 3A). Here, in situ sXRD analysis mainly focused on the general structural change upon delithiation/lithiation because the reflections of layered R3̅m and Fm3̅m rocksalt partially overlap with those of in situ pouch cell. Clearly, there is no new phase formation upon electrochemical cycling. Strikingly, the lattice parameters a and c of layered R3̅m component exhibited an isotropic change, as evidenced by all reflections shifting to a slightly higher diffraction angle upon charging and shifting back upon discharging. Such isotropic change in crystal lattice upon electrochemical cycling was further verified by ex situ sXRD collected on the cycled electrodes at different states of charge. More importantly, the layered-rocksalt intergrown structure still remained even after 100 cycles. Indeed, conventional layered oxides of R3̅m structure experienced an anisotropic change, which is characterized by a gradual increase in c lattice parameter accompanied by a slight decrease in a lattice upon delithiation, due to the change in ionic radius of TM and repulsion between the TM slabs at different states of charge. In sharp contrast, although with 70 mol % layered R3̅m phase, Li_{1.2}Ni_{0.4}Ru_{0.4}O₂ displayed an isotropic structural change, resembling that of Li-excess disordered rocksalt. Therefore, 30 mol % intergrown rocksalt can effectively manipulate the slabs of the layered matrix so that an isotropic lattice change becomes dominant upon delithiation/lithiation.

Furthermore, a series of LiₓNi_{0.4}Ru_{0.4}O₂ samples at varied states of delithiation were prepared via a chemical delithiation method for the detailed analysis of the structural evolution of each component. sXRD patterns of chemically delithiated LiₓNi_{0.4}Ru_{0.4}O₂ (FIG. 3B) were consistent with those obtained from the electrochemical cells. All the characteristic reflections retain upon delithiation. Close comparison revealed a very small shift towards the higher 2θ angle. For Li_{0.5}Ni_{0.4}Ru_{0.4}O₂, the most pronounced change is the decrease in the intensity of the reflections at 10.9, 12.7, and 17.9° (λ=0.4577 Å), which are characteristic of the rocksalt component, suggesting the delithiation perhaps starts from Fm3̅m rocksalt. The refinement of the ND reflection of chemically delithiated Li_{0.5}Ni_{0.4}Ru_{0.4}O₂ sample also indicated the preference of Li⁺ extraction from rocksalt rather than layered phase during initial Li⁺ extraction, as evidenced from the slightly higher lithium content in the R3̅m phase than in the Fm3̅m phase. These results imply the two-dimensional Li⁺ diffusion channels of layered R3̅m can help facilitate the extraction of Li⁺ from the intergrown Fm3̅m rocksalt.

The chemically delithiated Li_{0.2}Ni_{0.4}Ru_{0.4}O₂ sample was further investigated as it was close in composition to the electrode electrochemically charged to 4.6 V, with almost 1 Li⁺ extracted from Li_{1.2}Ni_{0.4}Ru_{0.4}O₂. Joint sXRD and ND refinement based on biphasic model generated a final R-factor of 8.0% (FIGS. 3C and 3D). It is worth noting that both lattice parameters a and c of the layered R3̅m component show an exceptionally low change of ˜1%, which can be referred to as “nearly zero-strain” electrode. Moreover, the fraction of layered R3̅m and Fm3̅m rocksalt is consistent with that of the pristine state, suggesting the delithiation process does not alter the overall phase composition. Therefore, the layered-rocksalt intergrown phase displays an excellent structural robustness with the minimal change in lattice parameters upon delithiation/lithiation.

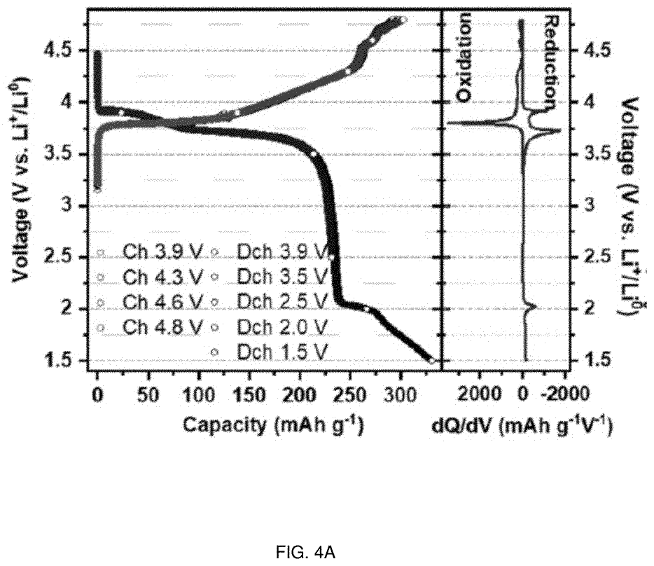

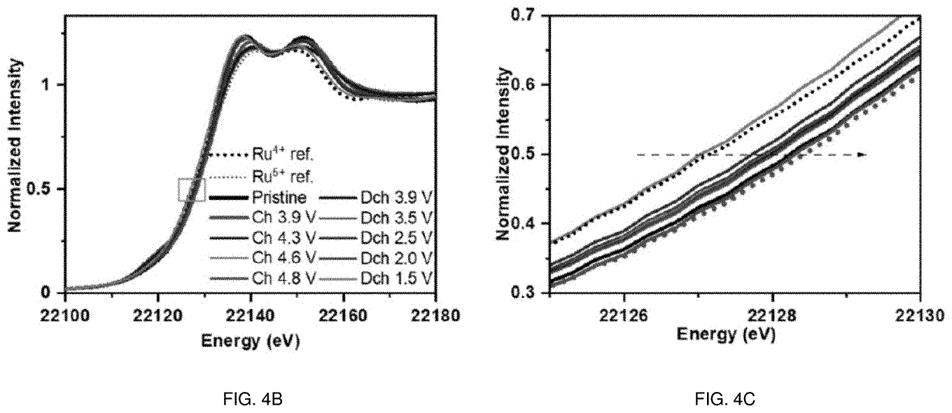

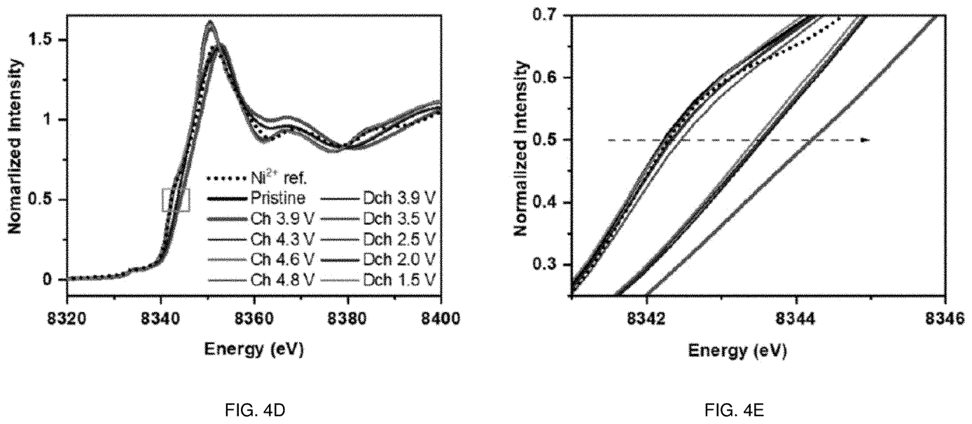

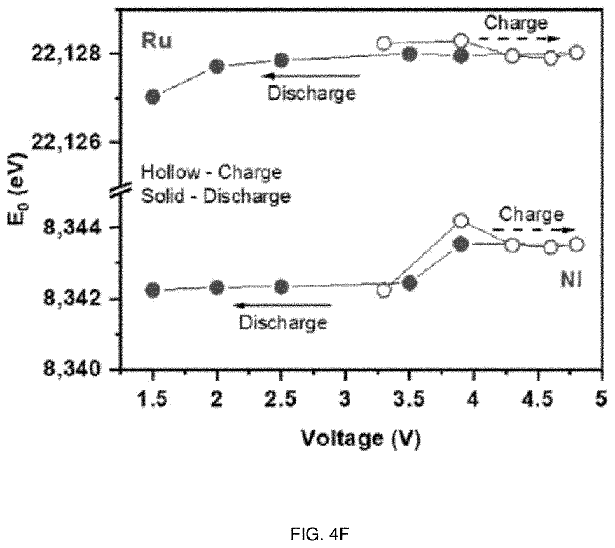

Results—Cationic Transition Metal Redox Mechanism. In parallel with the structural evolution study, the oxidation states of Ni and Ru at pristine and different states of charge were probed using hard X-ray absorption spectroscopy (XAS) to determine the charge compensation mechanism of TMs. Samples that are of interest were selected for detailed characterization based on the dQ/dV plot (FIG. 4A). From hard XAS (FIG. 4B-4E), the energy of Ru and Ni at half maxima is consistent with charged Li₂RuO₃ (dotted line in FIGS. 4B and 4C) and LiNi_{1/3}Mn_{1/3}Co_{1/3}O₂ (dotted line in FIGS. 4D and 4E), implying Ru⁵⁺/Ni²⁺ combination in pristine Li_{1.2}Ni_{0.4}Ru_{0.4}O₂. When the electrode was charged to 3.9 V, Ru K-edge energy remained consistent with Ru⁵⁺ reference because Ru⁵⁺ cannot be further oxidized, while the Ni K-edge shifted from Ni²⁺ reference to a higher energy, a clear indication of Ni oxidation. Interestingly, both Ru and Ni K-edge showed an abnormal shift to a lower energy upon further charging to 4.3 V and beyond, up to 4.8 V, indicating the “reduction” of Ru and Ni upon charging in the high voltage region. Ni reduction at highly charged state was further verified by 2D transmission X-ray microscopy (TXM) measurement. These results further confirmed that other oxidation reaction beyond TM such as O accounts for the Li⁺ extraction in the high voltage region. Upon discharge, K-edge energy remains same until 2.0 V for Ru and 3.9 V for Ni, implying no cationic TM redox by 3.9 V. Therefore, cathodic peak at 4.0 V (FIG. 2B and 2E) can be unambiguously attributed to anionic O reduction. Further discharging to 1.5 V led to Ru reduction to 4+ because Ru K-edge energy at 1.5 V matches that of pristine Li₂RuO₃ (dotted line in FIGS. 4B and 4C). After 3.9 V discharge, Ni K-edge showed a significant shift to a lower energy, close to pristine 2+, which was fully recovered at 2 V and showed no further change upon discharging to 1.5 V, therefore, Ni redox largely accounted for the anodic/cathodic peaks around 3.75 V (FIGS. 2B and 2E). Such a trend in TM oxidation state change upon charging/discharging can be easily visualized in FIG. 4F, also confirmed by Extended X-ray Absorption Fine Structure (EXAFS). Overall, Ni and Ru were present as 2+ and 5+ at pristine state, Ni redox mainly accounts for cationic TM redox while Ru remains inactive. We also infer that O participates in the electrochemistry in the high voltage region, accounting for the second redox around 4 V, which is further discussed below.

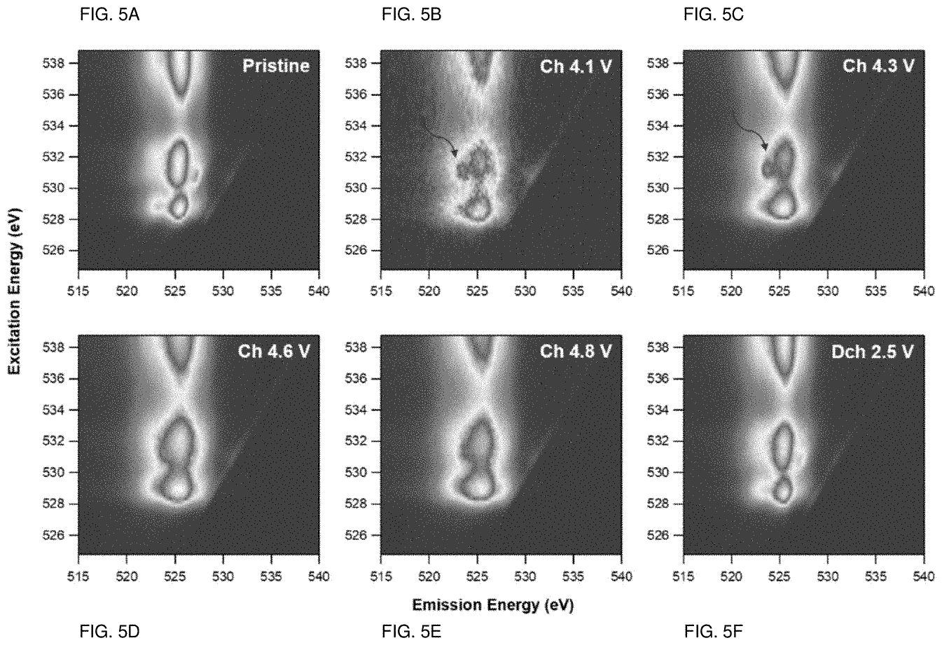

Results—Anionic Oxygen Redox Mechanism. Both electrochemistry (FIGS. 2A-2E) and TM XAS (FIG. 4A-4F) indicated that anionic oxygen participates in the electrochemistry of Li_{1.2}Ni_{0.4}Ru_{0.4}O₂ in the high voltage region. We therefore performed high-efficiency mapping of resonant inelastic X-ray scattering (mRIXS) at O K-edge, which has been established as a reliable probe of lattice oxygen redox. In general, the mRIXS images (FIGS. 5A-5F) were dominated by three broad features around 525 eV emission energy (horizontal axis), which are typical O²⁻ features for oxides with excitation energies (vertical axis) of 528-533 eV and above 535 eV, corresponding to the TM-d and -s/p states hybridized to O-2p states, respectively. Note the excitation energy here was same as that in typical O-K soft XAS spectra, but mRIXS is capable of differentiating the intrinsic oxidized oxygen signals from the dominating TM characters along the new dimension of emission energy, revealing a fingerprinting feature of lattice oxygen redox state at 523.7 eV emission energy (FIGS. 5B and 5C). This particular mRIXS feature corresponds to the electron excitation into unoccupied O-2p states, thus fingerprinting the lattice oxidized oxygen because O²⁻ has no unoccupied 2p states. This oxidized oxygen feature emerges when the Li_{1.2}Ni_{0.4}Ru_{0.4}O₂ electrode was charged to 4.1 V. Given about 0.8 Li⁺ is extracted from Li_{1.2}Ni_{0.4}Ru_{0.4}O₂ at 4.1 V charge, oxygen oxidation takes place with almost full oxidation of Ni²⁺ to Ni⁴⁺, consistent with our TM XAS results (FIG. 4A). The intensity of the lattice O redox feature increased upon further charging, while the hybridization features along 525 eV emission energy also were enhanced due to the increasing covalency of the overall system upon charging. At 4.6 and 4.8 V charged states, the two groups of growing features overlapped, but the oxidized oxygen feature remained clear via a direct comparison of the individual RIXS spectra cut out from the mRIXS image along 531 eV excitation energy. Additionally, such oxidized lattice oxygen feature completely disappeared at 2.5 V discharged state, indicating a reversible oxygen redox reaction.

Note that typical oxygen-redox-active Li-rich compounds always display a finite amount of broadening of the mRIXS features after discharge compared to pristine state, because of their severe structural changes during the initial cycle. In contrast, the Li_{1.2}Ni_{0.4}Ru_{0.4}O₂ electrode at discharged state recovered completely to its pristine state. Again, this is highly consistent with the robustness of such layered-rocksalt intergrown structure upon cycling. The reversible lattice oxygen redox during the charge and discharge of Li_{1.2}Ni_{0.4}Ru_{0.4}O₂ is further supported by the gas evolution measured by operando differential electrochemical mass spectrometry (DEMS), showing minimal oxygen and CO₂ gas release during the first cycle. A burst of CO₂ evolution at 4.3 V charge mostly originates from the carbonate residual from the synthesis. Therefore, we clearly revealed that the lattice oxygen redox is mostly reversible in Li_{1.2}Ni_{0.4}Ru_{0.4}O₂ with negligible irreversible O loss, which is of critical importance not only for practical utilization of combined cationic and anionic redox reactions, but also for fundamental understanding to differentiate these two oxygen activities, i.e., lattice oxygen redox and oxygen loss.

Discussion Materials exhibiting a robust structure upon the high-capacity cycling are important for high-performance batteries. With Li_{1.2}Ni_{0.4}Ru_{0.4}O₂, we demonstrated that a high capacity through combined TM/O redox and nearly zero-strain isotropic structural change were enabled in layered-rocksalt intergrown structure. Based on the successful demonstration of Li_{1.2}Ni_{0.4}Ru_{0.4}O₂, we further explored the formation of such intergrown structures of other compositions, aiming to extrapolate the universal material design principle. We took our initial consideration based on the ionic radius of the TM. Generally, ordered layered oxides are favored when the radius size of the TM cation is largely differed from that of Li⁺. Cation mixing between Li and TM tends to occur for the TM ions with a radius size similar to Li⁺ (0.76 Å), such as Ni²⁺ (0.69 Å), Mn²⁺ (0.67 Å), Mn³⁺ (0.65 Å). Additionally, the electronic structure of the TM cation also plays a critical role in the formation of ordered layered and disordered rocksalt structure. The more electrons on d shell, the more difficult to distort electronic structure and accommodate the strain associated with rocksalt phase formation. Therefore, d⁰ TM with fully distortable electronic structure prefers rocksalt formation, while layered phase formation is more feasible for d⁶ TM with fixed electronic structure. For example, the early transition metals with d⁰ orbital (e.g., Ti⁴⁺, Nb⁵⁺ and Mo⁶⁺), the electronic configuration of which promotes the formation of the disordered rocksalt. Therefore, the general principle to design such intergrown structures is to choose the TM cation with comparable radius size to Li⁺, combined with the TM featuring less distortable electronic configuration, to form the disordered rocksalt and ordered layered structure, respectively.

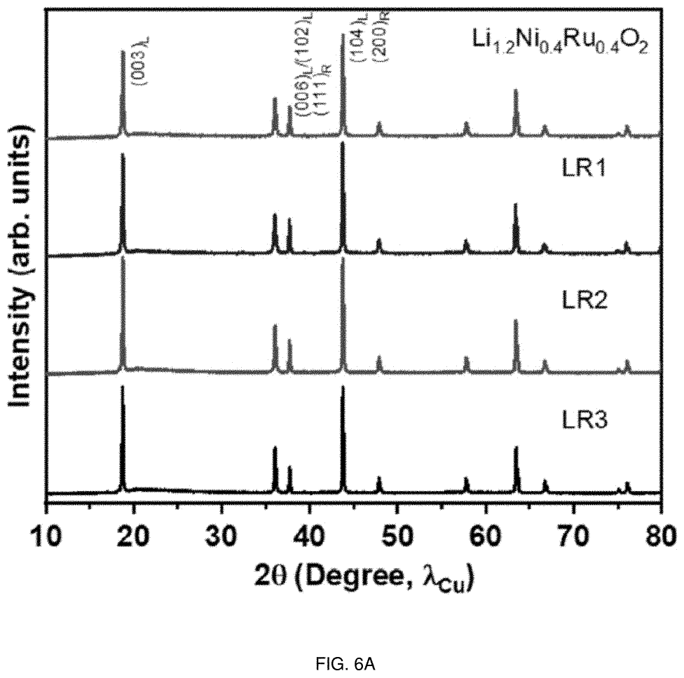

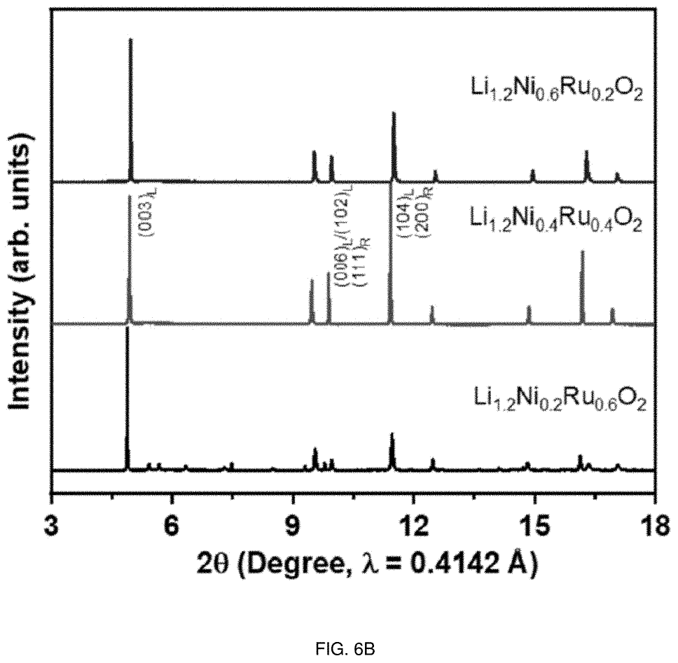

In this case, the combination of Ni²⁺ (0.69 Å) and Ru⁵⁺ (0.57 Å, 4d³) led to the formation of layered-rocksalt intergrown structure. Indeed, this combination of Ni²⁺ and Ru⁵⁺ enables the intergrown structure in a quite reasonable composition range (FIG. 6A). Rietveld refinement analysis showed the molar ratio of rocksalt phase gradually increases from 20.7% to 32.6% with increasing Ni content or Ni/Ru ratio (from 0.5 to 1.14), indicating the effect of the composition on the phase ratio in the intergrown structure. The valence state of Ni and Ru in the designed samples was confirmed to be 2+and 5+, respectively, by XANES. Furthermore, synchrotron XRD studies on these design samples at various states of charge revealed Li_{7/6}Ni_{4/9}Ru_{7/18}O₂ (LR1) and Li_{5/4}Ni_{1/3}Ru_{5/12}O₂ (LR2) samples at charged state show similar isotropic structural evolution resembling that of Li_{1.2}Ni_{0.4}Ru_{0.4}O₂ sample. However, Li_{4/3}Ni_{2/9}Ru_{4/9}O₂ (LR3) sample does not exhibit a similar change, instead, the (003) peak splits to two peaks. In combination with Rietveld analysis, only 20.7% rocksalt phase in the final material is not sufficient to completely suppress the anisotropic structural change. Herein, d³ Ru⁵⁺ with partial flexibility in electronic structure can possibly accommodate both layered and rocksalt structure.

Alternatively, the utilization of Ru⁵⁺ (0.57 Å, 4d³) with smaller Ni³⁺ (0.56 Å) in Li_{1.2}Ni_{0.6}Ru_{0.2}O₂ or Ni^{2+'}(0.69 Åwith Ru⁴⁺ (0.62 Å, 4d⁴) in Li_{1.2}Ni_{0.2}Ru_{0.6}O₂ led to a layered structure (FIG. 6B). The formation of these layered oxides can be explained by the ionic radius and electronic configuration of different cations. For example, in Li_{1.2}Ni_{0.6}Ru_{0.2}O₂, the small Ni³⁺ is the dominating cation and does not favor Li⁺ displacement to form rocksalt phase, while in Li_{1.2}Ni_{0.2}Ru_{0.6}O₂, the electronic configuration of dominating Ru⁴⁺ (4d⁴) plays a key role in the formation of the final phase. These results indicate that the considerations of TM ionic radius and electronic configuration are effective for the design of such layered-rocksalt intergrown materials. We note this design principle can be applied to abundant and low-cost 3d TMs, which is critically important for the further development of layered-rocksalt intergrown cathodes. One example is the design and synthesis of a series of compounds based on the combination of Ni²⁺, Fe³⁺ and Mn⁴⁺. Of these cations, Ni²⁺ (0.69 Å) and Fe³⁺ (0.645 Å) have similar ionic radius to Li⁺ (0.76 Å), facilitating cation mixing and rocksalt phase formation. In comparison, the role of Mn⁴⁺ (0.53 Å, 3d³) is similar to that Ru⁵⁺ (0.57 Å, 4d³), its different ionic radius from Li⁺ and distortable electronic configuration enable the formation of layered structure. As-designed materials showed evidence of the layered-rocksalt intergrown structure. Furthermore, the HAADF-STEM image and EELS mapping collected on one representative Li—Ni—Fe—Mn—O sample, Li_{1.15}Ni_{0.20}Fe_{0.15}Mn_{0.50}O₂, showed the intergrown structure of the layered and rocksalt phases with uniform elemental distribution.

We would emphasize again that the layered-rocksalt intergrown material inherits the advantages of both phases, displaying high-capacity and low-hysteresis electrochemical profiles with nearly zero-strain isotropic structural evolution upon electrochemical cycling. The intriguing finding of the coupled cationic TM “reduction” and anionic O oxidation with negligible irreversible oxygen release not only provides the practical optimism, but also inspires future studies on the importance of TM-O interactions for oxygen activities in oxygen-redox-active systems. Overall, combination of these high-performance features in a single material is not trivial, making it a very promising direction for the search of advanced battery cathodes. Most importantly, layered and rocksalt phases are structurally compatible, so a large composition space is opened up for the search of commercially viable materials with such layered-rocksalt intergrown structure for advanced Li-ion batteries.

Methods—Synthesis. Li-rich metal oxides, Li_{1.2}Ni_{0.4}Ru_{0.4}O₂, along with other Li—Ni—Ru—O derivatives, were prepared using Li₂CO₃, Ni(OH)₂, and RuO₂ as precursors. The precursors at designated stoichiometric amounts were first mixed on a Spex 8000 mill for 3 h, then fired at 450° C. for 3 h and 950° C. for 15 h in air, unless noted otherwise. The synthesis of this material via a solid-state reaction was reproducible. Chemically delithiated samples were prepared by reacting Li_{1.2}Ni_{0.4}Ru_{0.4}O₂ with stoichiometric amounts of 0.1 M nitronium tetrafluoroborate (NO₂BF₄) in acetonitrile inside an Ar-filled glovebox (H₂O<0.1 ppm) overnight. 1 fold excess NO₂BF₄ was used to prepare fully delithiated sample. The final products were obtained by filtering and thoroughly washing the resulting mixtures by acetonitrile until the residual solution was clear, then drying under vacuum overnight. The compositions of final LiₓNi_{0.4}Ru_{0.4}O₂ (1.2≤x<0) and other Li—Ni—Ru—O derivatives were determined by inductively coupled plasma mass spectrometry (ICP-MS) analysis. Li—Ni—Fe—Mn—O derivatives were prepared by using Li₂CO₃, Ni(OH)₂, FeC₂O₄ and MnCO₃ as precursors. The precursors of designated stoichiometry were first mixed on a Spex 8000 mill for 3 h, followed by a calcination process at 450° C. for 3 h and 900° C. for 16 h in air.

Methods—Electrochemistry. Electrodes were prepared from slurries containing 80 wt % of active material, 10 wt % of polyvinylidene fluoride (PVdF) binder, and 10 wt % acetylene carbon black (50% compressed) in Nmethylpyrrolidone solvent. The slurries were caste on carbon-coated aluminum current collectors using a doctor blade, and then dried under vacuum at 120° C. overnight. Typical loading of the active materials was ˜2.5 mg cm⁻². 2032-type coin cells containing Li metal, a Celgard 2400 separator, and 1M LiPF₆ electrolyte solutions in 1:2 w/w ethylene carbonate-diethyl carbonate were assembled in an Ar-filled glove box (H₂O<0.1 ppm). Galvanostatic charge and discharge were performed on a cycler at designated rates and voltages. 1C capacity was defined as 250 mA g⁻¹.

### CONCLUSION

Further detail regarding the embodiments described herein can be found in Li, N., Sun, M., Kan, W. H. et al. Layered-rocksalt intergrown cathode for high-capacity zero-strain battery operation. Nat Commun 12, 2348 (2021).

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A structure comprising an oxide including lithium and two or more transition metals, a first portion of the oxide being in a layered phase and a second portion of the oxide being in a rocksalt phase, the first portion of the oxide and the second portion of the oxide forming a layered-rocksalt intergrown structure.

2. The structure of claim 1, wherein the layered-rocksalt structure comprises nanodomains of the rocksalt phase dispersed in the layered phase.

3. The structure of claim 2, wherein the nanodomains are about 3 nanometers to 100 nanometers in size.

4. The structure of claim 1, wherein the structure comprises about 20 mol percent to 33 mol percent of the rocksalt phase and about 67 mol percent to 80 mol percent of the layered phase.

5. The structure of claim 1, wherein the transition metals comprise nickel and ruthenium.

6. The structure of claim 1, wherein the oxide comprises a lithium nickel ruthenium oxide.

7. The structure of claim 1, wherein the oxide comprises Li[Li_{1-x-y}(Ni²⁺)ₓ(Ru⁵⁺)_{y}]O₂, and wherein 0.03<1-x-y<0.47.

8. The structure of claim 1, wherein the oxide is selected from a group consisting of Li_{1.2}Ni_{0.4}Ru_{0.4}O₂, Li_{7/6}Ni_{4/9}Ru_{7/18}O₂, Li_{5/4}Ni_{1/3}Ru_{5/12}O₂, and Li_{4/3}Ni_{2/9}Ru_{4/9}O₂.

9. The structure of claim 1, wherein the transition metals comprise nickel, iron, and manganese.

10. The structure of claim 1, wherein the oxide comprises a lithium nickel iron manganese oxide.

11. The structure of claim 1, wherein the oxide comprises Li[Li_{1-x-y-z}NiₓFe_{y}Mn_{z}]O₂, and wherein 0.03<1-x-y-z<0.47.

12. The structure of claim 1, wherein the oxide is selected from a group consisting of Li_{1.15}Ni_{0.20}Fe_{0.15}Mn_{0.50}O₂, Li_{1.15}Ni_{0.15}Fe_{0.25}Mn_{0.45}O₂, Li_{1.10}Ni_{0.20}Fe_{0.30}Mn_{0.40}O₂, and Li_{1.10}Ni_{0.30}Fe_{0.10}Mn_{0.50}O₂.

13. The structure of claim 1, wherein the oxide includes a dopant selected from a group consisting of Sc, Ti, V, Cr, Co, Cu, Zn, Y, Zr, Nb, Mo, Ta, and W, and wherein 0<(dopant atomic percentage)≤0.1.

14. The structure of claim 1, wherein the structure is incorporated in a cathode of a lithium-ion battery.

15. A method for manufacturing a lithium metal oxide including lithium and two or more transition metals, a first portion of the oxide being in a layered phase and a second portion of the oxide being in a rocksalt phase, the first portion of the oxide and the second portion of the oxide forming a layered-rocksalt intergrown structure, and having a general formula Li[Li_{1-x-y}(Ni²⁺)ₓ(Ru⁵⁺)_{y}]O₂, with 0.03<1-x-y<0.47, comprising:
providing a lithium-based precursor;
providing a nickel-based precursor;
providing a ruthenium-based precursor;
mixing the lithium-based precursor, the nickel-based precursor, and the ruthenium-based precursor to form a mixture.

16. The method of claim 15, further compromising:
after the mixing, annealing the mixture at about 700° C. to 1200° C. for about 5 hours to 18 hours under an oxygen atmosphere or in air.

17. The method of claim 15, wherein the lithium-based precursor is selected from a group consisting of Li₂CO₃, LiOH, Li₂O, Li₂SO₄, LiCl, LiNO₃, and combinations thereof.

18. The method of claim 15, wherein the nickel-based precursor is selected from a group consisting of NiO, Ni₂O₃, Ni(OH)₂, and NiCO₃, and wherein the ruthenium-based precursor comprises RuO₂.

19. The method of claim 15, wherein stoichiometric amounts of the lithium-based precursor, the nickel-based precursor, and the ruthenium-based precursor are mixed, and wherein the lithium-based precursor is added in up to 15% excess of a specified lithium composition.

20. A battery comprising:
an anode;
a cathode, the cathode comprising an oxide including lithium and two or more transition metals, a first portion of the oxide being in a layered phase and a second portion of the oxide being in a rocksalt phase, the first portion of the oxide and the second portion of the oxide forming a layered-rocksalt intergrown structure; and
an electrolyte.
